(19) United States
(12) Patent Application Publication
(10) Pub. No.: US 2005/0211910 A1
(43) Pub. Date: Sep. 29, 2005

(54) Morphology and Spectroscopy of Nanoscale Regions using X-Rays Generated by Laser Produced Plasma

(75) Inventors: Scott H. Bloom, Encinitas, CA (US); Harry Rieger, San Diego, CA (US)

Correspondence Address: BAKER & MCKENZIE;PATENT DEPARTMENT, 2001 ROSS AVENUE, SUITE 2300, DALLAS, TX, 75201, US

(73) Assignee: JMAR RESEARCH, INC., San Diego, CA (US)

(21) Appl. No.: 10/907,321

(22) Filed: Mar. 29, 2005

Related U.S. Application Data
(60) Provisional application No. 60/557,364, filed on Mar. 29, 2004.

(51) Int. Cl. H01S 3/10

(52) U.S. Cl. 250/423 P; 250/281

(57) ABSTRACT

A system and method is disclosed for generation of a nanoplasma and/or nanofluorescence. The system includes an emissions source of soft x-rays. The emissions source can include a laser system as an energy source and target material that acts as a radiation source when illuminated by the laser system. The system further includes focusing optics particularly suited for manipulation of wavelengths associated with x-rays. The focusing optics can focus the x-rays onto a desired target so that a nanoplasma or nanofluorescent spot can be formed to have a diameter of less than 200 nm. Radiation from the nanoplasma or nanofluorescent spot can be examined, for example using a spectrometer, in order to perform a highly-selective material analysis of the desired target. Other applications include using the nanoplasma for nanoablation and/or nanodeposition processes.

### CROSS-REFERENCE TO RELATED APPLICATIONS

This application claims priority to U.S. Provisional Patent Application No. 60/557,364, filed Mar. 29, 2004 entitled “Nanometer Surface Ablation for Micro-Plasma Spectrometry,” the entire contents of which is hereby incorporated by reference.

### FIELD OF THE INVENTION

This disclosure relates to techniques and apparatuses for forming nano-scale plasmas on a desired sample for a variety of applications, including materials analysis, nanomachining, and nano-scale chemical vapor deposition.

### BACKGROUND

Nanoscale materials, in particular materials that have spatial chemical variations on the nanometer scale, are currently being aggressively pursued a variety of research and development groups. Applications of these materials are wide-ranging and potentially revolutionary. In order to develop such materials, diagnostic techniques capable of producing accurate, sensitive, chemical analysis on the spatial scale of the nanomaterial itself are required. There are currently many materials analysis techniques available to analyze surfaces and interfaces, most use a spectrometer looking at emitted radiation, emitted photoelectrons, or emitted ions from the material under analysis. While these techniques are quite reliable and sensitive, they currently do not have the capability to analyze materials, particularly in-situ, on the spatial scales required for nano technology.

Current techniques for materials and surface analysis are generally limited by diffraction to sample spatial resolutions greater than 200 nm whereas it is projected that the spatial sizes needing to be sampled for new materials will be in the 20-200 nm range. There are some techniques available for probing materials at such resolutions, usually based on atomic force microscopy (AFM) or near-field scanning optical microscopy (NSOM) techniques, which are in general somewhat slow and tedious to use since the probe is nearly in contact with the sample. A radiation-based mechanism permits non-contact sample interaction that usually translates into increased speed or area examined.

One technique for obtaining sample spectrochemistry is laser-induced breakdown spectroscopy (LIBS), where a laser beam is tightly focused to a sample, ablates the sample, and then ionizes the ablated material into a plasma. Emission spectra from the plasma are collected and run into a spectrometer where various chemicals can be identified based on the positions of peaks on the recorded spectrum. For nanoscale materials, physics imposes a limit on the smallest size spot at which a laser can be focused, about 1.22× the wavelength of the laser. Therefore, even for a 193 nm excimer laser, the smallest obtainable sample size is about 200 nm. This resolution is not high enough to examine nanomaterials that are expected to have chemical variations at the 20-200 nm scale.

### SUMMARY

In view of the shortcomings associated with the prior art, an innovative nanoplasma technique is disclosed for analyzing the properties of a material on a nanoscale using laser-produced plasma x-rays. Soft x-rays have wavelengths in the range of 0.5-160 nm and therefore the diffraction-limited spot size of focused x-rays can be as small as 1.22× the radiation wavelength, or less than 200 nm spot size. Also, when focused to a 10-30 nm spot size, an x-ray souurce will deliver enough power per unit area to form a nanoplasma. A soft x-ray source has demonstrated more than 20 W of x-ray power into 2πsr. Focusing a small collected solid angle of this x-ray radiation is more than enough power to form a very hot plasma that emits a range of radiation from UV through IR that can be collected and analyzed on an optical spectrometer. Since the radiation used to form the plasma is soft x-rays, for example as opposed to UV from a laser, the focused spot size is much smaller in diameter and therefore suitable for studying materials at nanoscale spatial resolutions. Optionally, ions ablated by the nanoplasma can be swept from the region of interest using electromagnetic fields into a time-of-flight mass spectrometer that could give additional information about the material, still at nanoscale spatial resolution, not available in the emitted radiation. Soft x-ray radiation suitable for this application is available from a laser-produced plasma source. Other methods of producing soft x-rays include a synchrotron and a gas discharge source. However, these methods generally cannot produce enough photons in a short enough burst (e.g., synchrotron) or have a source size that is too large to image to a small spot at the required intensity (e.g., gas discharge).

### BRIEF DESCRIPTION OF THE DRAWINGS

The present invention is illustrated by way of example and is not limited by the figures of the accompanying drawings, in which like reference numbers indicate similar parts:

FIG. 1 shows a schematic block diagram of a system using a laser-produced plasma x-ray source for nanoplasma spectroscopy or other applications;

FIG. 2 shows a schematic block diagram of a first embodiment of an x-ray nanoplasma spectroscopy system;

FIG. 3 shows a schematic block diagram of a second embodiment of an x-ray nanoplasma spectroscopy system;

FIG. 4 shows a schematic block diagram of a third embodiment of an x-ray nanoplasma spectroscopy system;

FIG. 5 shows a schematic block diagram of a fourth embodiment of an x-ray nanoplasma spectroscopy system;

FIG. 6 shows a schematic diagram of a deposition process using a nanoplasma system; and

FIGS. 7A-7F show schematic diagrams of an ablation process using the system shown in FIG. 1.

### DETAILED DESCRIPTION

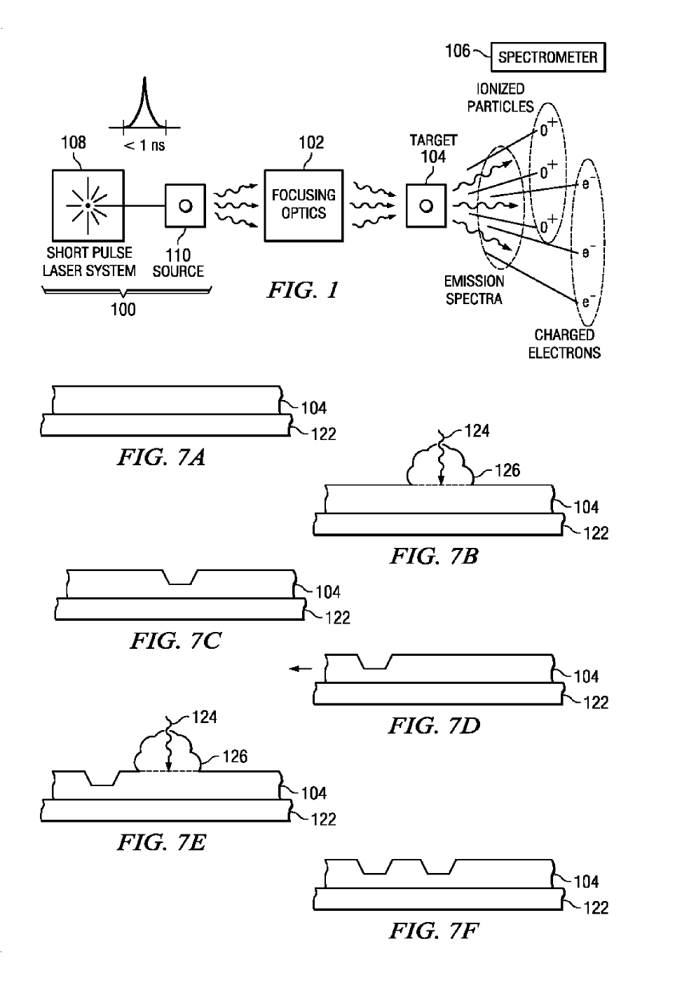

Disclosed herein is a system and method for performing a chemical analysis of a sample. As shown in FIG. 1, an exemplary system generally comprises an emissions source 100, an emissions optical system 102 for collecting and/or directing the emissions, a target sample 104 that forms a plasma when irradiated with the emissions, and analysis instrumentation 106 for analyzing radiation emitted from the plasma.

Emissions Source

In the arrangement shown in FIG. 1, the emissions source 100 includes a laser system 108 as an energy source and a target material 110 as a radiation source. Preferably, the emissions source 100 is sufficient to deliver enough power per unit area when focused to a very small spot size, for example having a diameter of 50 nm or less, to form a nanoplasma. Preferably, the emissions source 100 serves as a source for short wavelength radiation. Desirable wavelengths can be those associated with x-rays, including soft x-rays, for example having a wavelength in the range of 0.5-160 nm. High-intensity laser ionization of the target material 110 can generate an x-ray point source. For instance, x-rays can be produced by focusing ˜10¹⁵ W/cm² of 1.06μ of light onto a thin Copper (Cu) tape. In another preferred embodiment, the target material 110 can be constructed of Mylar, such as a Mylar foil (C₁₀H₈O₄), where the C K-shell emission is 3.37 nm. Thus, it is preferable that the target material 110 be such that it emits short-wavelength radiation when illuminated by a pulse from the laser system 108. The target material 110 can therefore be formed from any desired material that emits radiation of a desired wavelength when irradiated by an appropriate energy source. For example, using a laser to induce L-shell emissions, Copper (Cu) emits ˜1.1 keV x-rays, Nickel (Ni) emits ˜1.0 keV x-rays, Zinc (Zn) emits ˜1.2 keV x-rays, Gallium (Ga) emits ˜1.3 keV x-rays, Germanium (Ge) emits ˜1.4 keV x-rays, Indium (In) emits ˜4 keV x-rays, and Tin (Sn) emits ˜4 keV x-rays. By irradiating at higher laser intensities, K-shell emissions can be induced from Beryllium (Be) (˜0.1 keV), Boron (B) (˜0.2 keV), Carbon (C) (˜0.3 keV), Chlorine (Cl) compounds (˜2.8 keV), Titanium (Ti) (˜4.8 keV), Gallium (Ga) (˜10 keV), and Indium (In) (˜29 keV). It will be appreciated that other emissions at different energy levels can also be induced.

Preferably, the emissions source 100 serves as a soft x-ray generator, capable of generating x-ray emissions, including those having a wavelength in the range of 0.5-160 nm. To accomplish this, examples of suitable laser systems for use as the laser system 108 include the BriteLight™ laser available from JMAR Technologies, Inc. of San Diego, Calif., and laser systems described in U.S. Pat. Nos. 5,434,875; 5,491,707; and 5,790,574, all of which are hereby incorporated by reference into this description. In a preferred embodiment, the laser system can include a master oscillator (MO) and an amplifier, where the MO is an Nd:YAG rod longitudinally pumped by a diode array with micro-lenses. The MO resonator has several optical elements to produce an output of 1 mJ/pulse at 1000 Hz with <1 ns pulse duration and near-diffraction limited beam quality. The amplifier can be a diode-pumped amplifier that increases the pulse energy, for example to an amount>50 mJ at 300 Hz providing for 15 W average power. Additional amplifiers can be included to obtain over 75 W. Further examples of x-ray sources suitable for use as the emission source 100 are described in U.S. Pat. Nos. 5,089,711 and 5,539,764, which are both hereby incorporated by reference into this description.

The target material 110 can be in the form of a solid block; however, other forms can be preferable. For example, one embodiment of target material can be that of a tape or ribbon, for example as disclosed in U.S. Pat. No. 5,539,764. The tape or ribbon can be a roll of target tape, where the tape is one-half inch in width and approximately 10-20 microns thick. The roll of target tape can be dispensed at a predetermined rate while a laser beam pulse from the laser system 100 irradiates the tape at a desired frequency. The fast ions ablated from the target material 110 are ejected away from the target. The plasma-generated shock wave breaks through the tape and ejects most of the target material 110 to a location where it can be collected. Thus, the use of target material in the form of a tape substantially reduces ion contamination of other system components when compared with solid blocks of target material.

In order to further reduce material contamination, a filtering gas can be circulated in the vicinity of the target material 110. For example, it is preferable to use nitrogen as a filtering gas for the case where a Mylar target is used. In other embodiments, such as where a copper tape target is used, Helium can be used as a filtering gas. If the target material 110 is located within an x-ray chamber, the x-ray chamber can be filled with a filtering gas. For example, where He gas is used in conjunction with a Cu target, He flow at 50 torr can be used with a shroud to reduce or stop contamination. As the filtering gas is circulated within the x-ray chamber it removes the ablated ions. As ions are ablated from the target material, atoms of the filtering gas collide with the high-velocity ions, stopping the ions within a few centimeters from the target position. As the gas/ion mixture is re-circulated within the x-ray chamber, filters can be used to trap the ions, recirculating only the filtering gas at the completion of the filtration process. The use of thin tape targets and helium gas to stop ablated ions from contaminating the x-ray chamber is described in more detail in Turcu, et al., High Power X-ray Point Source For Next Generation Lithography, Proc. SPIE, vol. 3767, pp. 21-32, (1999), which is hereby incorporated by reference.

Alternately, the target material 110 can be provided in other preferable forms. For example, the target material 110 can be in the form of a liquid droplet or a solid pellet, such as those described in pending U.S. patent application Ser. No. 09/699,142 (referred to hereinafter as the '142 application), which is hereby incorporated by reference. Preferably the pellets or droplets are substantially spherical with a diameter less than 1 cm, such as in a range of 10 to 100 microns, and free of any surface contaminants, debris, or irregularities. The droplets or pellets can be provided by a dispensing apparatus that dispenses droplets or pellets into the path of laser pulses emitted by the laser source 110. The '142 application describes many different types of dispensing apparatuses that can be incorporated into the emission system 100, particularly where droplet or pellet target materials are used.

Another option for the target material 110 can be a membrane as described in U.S. patent application Ser. No. 10/750,022, which is hereby incorporated by reference. The preferred thickness of the target membrane is in the range of about 0.1 μm to about 100 μm. Some embodiments can utilize a supporting aperture in which the membrane is formed and irradiated with a laser pulse from the laser source 108. In other embodiments, the target material can be a spherical membrane, similar to a bubble. Preferably, the spherical membrane will encase a gas that is of a low atomic number. Although the gas ideally comprises hydrogen, the reactivity of hydrogen gas makes it preferable to select inert gas, such as helium. Gasses with a lower atomic number are preferred because of their lower absorption of short-wavelength radiation. The membrane can be a molten material, for example tin, with good wetting properties to ensure that the molten material has sufficient surface tension to form a membrane in the aperture. Other embodiments can utilize a solution comprising a mixture of metallic compounds such as tin chloride (SnCl₂), zinc chloride (ZnCl), tin oxide (SnO₂), lithium (Li), a tin/lead mixture (Sn/Pb), and iodine (I), in a solvent such as water. Utilizing these solutions eliminates the requirement of maintaining the reservoir of target material above the melting point of a target material, such as tin (231° C.). In order to provide soft x-rays (˜3-5 nm), carbon-based membrane targets can be utilized. Examples of solutions comprising carbon-based microtargets include plastics, oils, and other fluid hydrocarbons.

Finally, another option for the target material 110 is to use a liquid target, where the liquid can be delivered using a liquid jet system. For example, a Xenon based liquid jet system can be used to provide radiation have a wavelength of ˜11 nm. It should be noted that ice or solid xenon could also be used to emit soft x-rays. Examples of ice targets include a thin sheet or cylindrical block of ice. The ice preferably is cooled by a heat pump, such as including liquid nitrogen reservoir placed in proximity to or in contact with the ice. In the case where a liquid target is provided, the liquid can be treated with additives such as zinc chloride, to adjust the emission spectrum. Likewise the solid component may be increased in this stream to the point where the stream comprises solid micropellets or clusters. For example, micropellets of tin or other suitable substances may be provided via a nozzle in a fluid (gas or liquid) stream.

It should be understood that the above-mentioned particular laser sources and x-ray sources are mentioned as examples and any x-ray source generating a sufficient x-ray flux (i.e. photons per unit area, per unit time, per unit of solid angle) can be used.

Emissions Optical System

The emissions optical system 102 serves primarily to collect emissions from the emissions source 100 and direct them to the target sample 104. In a preferred embodiment, the emissions optical system 102 is designed to collect soft x-rays emitted from the emissions source 100 and focus them to a spot having a diameter less than 200 nm, such as in a range of 20-200 nm. The emissions optical system 102 can be a static system, designed to be focused at a fixed point, in which case the target sample 104 can be controllably positioned as discussed below.

It will be appreciated that the optical design of the emissions optics 102 is dependent upon several factors, including the wavelength of emissions from the emissions source 100. It will also be appreciated that optical elements are aligned as necessary to control the path of x-rays from the emissions source 100 to the target sample 104, or from the target sample 104 to the analysis instrumentation 106. Since soft x-rays do not pass through most materials, x-ray optics using either diffractive elements, grazing incidence reflection, or multilayer Bragg reflection can generally be used. For systems with longer wavelengths, such as >8 nm, Bragg multilayer coatings can be made that have high reflectivity over large collection angles. For shorter wavelengths, grazing incidence or diffractive optics are generally more effective. Specific examples of optical designs for the emissions optics 102 are provided in the practical embodiments discussed below. However, it will be appreciated that these embodiments are provided only as examples and, as such, are not intended to be limiting. Rather, it will be apparent to those skilled in the art that other arrangements are possible, including variations of the arrangement and characteristic of elements of the optical design examples provided below.

Target Sample

The target sample 104 is a material undergoing analysis in the case of embodiments in which spectroscopy is being performed. In other embodiments, the target sample 104 can be representative of an article playing some alternative role in the overall system. For example, the system in FIG. 1 can be used for nanomachining or vapor deposition applications, in which case the target sample 104 can be a substrate, such as a wafer, being machined or having layers built thereupon. For spectroscopy applications, the target sample 104 can be a nanoscale material having variations, such as chemical or surface variations, that occur on the nanometer scale. In order to study such variations, the emissions system 100 and emissions optical system 102 preferably irradiate the target sample such that sample spatial resolutions less than 200 nm are possible, for example in a range of 20-200 nm.

In order to address various portions of the target sample 104, a fine-positioning system can be employed. Preferably, the positioning system provides for resolution in increments less than 200 nm or as small as possible, for example 10 nm. In a preferred embodiment, a piezoelectric motioning system can be used. High-resolution positioning stages having the capability of moving the target sample 104 in the required increments are commercially available and can be obtained from, for example, Physik Instrumente GmbH & Co., Polytec Platz 1-7, 76337 Waldbronn, Germany. Piezoelectric stages available from this company can provide movements on the nanometer scale along multiple axes.

Analysis Instrumentation

The system shown in FIG. 1 has utility in many different applications, including failure analysis, process control, and design applications. It will therefore be appreciated that the analysis instrumentation 106 can vary widely.

In some embodiments, the emissions source 100 can emit soft x-rays, which are used to form a nanoplasma on the target sample 104, and radiation from the nanoplasma can be analyzed using a spectrometer as the analysis equipment 106. For example, the spectrometer can be a photometric analyzer for analyzing material chemical composition via soft x-ray to infrared (IR) radiation. The spectrometer can also be an MS-TOF analyzer for analyzing material chemical composition via mass of ions emitted from the nanoplasma. The spectrometer can also be a photoelectron analyzer for analyzing the material surface chemicals.

Alternate System Applications

The system shown in FIG. 1 can also be used for numerous applications other than those discussed associated with spectroscopy. For example, embodiments of the system shown in FIG. 1 can include systems for nanomachining—performing material removal at nanometer levels—where x-rays emitted from the emissions source 100 form a nanoplasma on the target sample 104, thereby ablating a portion of the material.

FIGS. 7A-7F provide an example of how the system shown in FIG. 1 can be used for nanomachining or nanoablation of a target sample 104. FIG. 7A shows the target sample 104 supported by a fine-positioning stage 122. The fine-positioning stage 122 allows the target sample 104 to be positioned according to the location of the target sample 104 that is to be ablated. In FIG. 7B, the upper surface of the target sample 104 is exposed to a beam 124 of soft x-rays. The power associated with the beam 124 is sufficient for creating a nanoplasma 126 that ablates material of the target sample 104. After a prescribed amount of time, exposure to the beam 124 ceases. FIG. 7C shows a cavity 128 that has been formed by the ablation of the upper surface of the target sample 104. Next, in FIG. 7D the target material 104 is repositioned by the stage 122 in the direction indicated. The target material 104 is exposed again to the beam 124 of soft x-rays. This time, a second portion of the target material 104 is ablated, resulting in the formation of a second cavity 130 as shown in FIG. 7F.

Thus, using a nanomachining system that incorporates concepts disclosed herein, nanostructures can be constructed with a high level of precision. Nanomachining can include the repair of defects in semiconductor devices. Nanomachining can be used to provide for the precise and accurate removal of defects in quartz, chrome, MoSi, and various other materials. The system shown in FIGS. 1 and 7A-7F can provide for nanomachining with resolution in the range of 20-200 nm. In alternative embodiments, the position of the target sample 104 can be static, and the direction and/or position of the beam 124 can be controlled so that material of the target sample 104 is selectively ablated.

Further embodiments include those where the system shown in FIG. 1 is used for epitaxy or film deposition processes. For example, the system shown in FIG. 1 can be a system for performing Plasma Enhanced Chemical Vapor Deposition (PECVD) processing. In general, Chemical Vapor Deposition (CVD) is a process where gas molecules (precursor) are transformed into solid thin-film or powder material on the surface of a substrate, such as a wafer. In a PECVD system, plasma is used to decompose a reactant gas and deposit the reaction products onto a substrate surface. For example, as a precursor, silane (SiH₄) can be decomposed into Si (resultant) and H (byproduct) radicals, where the silicon precipitates on the surface of the substrate as a new layer. There are numerous materials that can be deposited via PECVD processing that are known to those skilled in the art, including conductors such as tungsten, copper, aluminum, transition-metal silicides, and refractory metals, semiconductors such as gallium arsenide, epitaxial and polycrystalline silicon, and dielectrics such as silicon oxide, silicon nitride, and silicon oxynitride.

In some embodiments of the system shown in FIG. 1, localized deposition systems can be realized, for example as shown in FIG. 6, where deposition is controlled to be confined to specific areas on the surface of the target sample 104 rather than uniformly spread over the entire surface. For example, the system shown in FIG. 1 can be a localized PECVD system where a nanoplasma can be formed on a surface of the target sample 104. An enlarged view of the surface of the target sample 104 is shown in FIG. 6. Reactive gas that includes precursors 112 can be circulated over the surface of the target sample 104. A nanoplasma 114 is formed by the impact of soft x-rays 116 onto a portion of the surface of the target sample 114. As the nanoplasma 114 reacts with the precursors 112, the precursors 112 react to form resultants 118 and byproducts 120. Resultants 118 are deposited on the surface of the target sample 104 in the vicinity of the nanoplasma 114. Since the nanoplasma 114 is required for volatilization of the precursors 112, and since the nanoplasma 114 is confined to a very small area, for example an area 20-200 nm in diameter, deposition can be controlled to a relatively small area on the surface of the target sample 114. In some embodiments, the localized deposition system can include a fine-positioning system. For example, as shown in FIG. 6, the target sample can be supported by a fine-positioning stage 122. The positioning stage 122 can be operable to reposition the target sample 104 in one or more directions and in increments as desired, for example in increments less than 200 nm. Thus, a highly localized PECVD process can be realized where a film could be deposited in a highly controlled, spatially-confined manner, particularly as compared with other PECVD processes.

It will be appreciated by those skilled in the art that similar embodiments of the system shown in FIG. 1 can include systems for performing plasma enhanced OrganoMetallic Chemical Vapor Deposition (OMCVD) or plasma enhanced OrganoMetallic Vapor Phase Epitaxy (OMVPE), which involve the use of organometallic precursors.

### Exemplary Embodiments

In view of the above discussion in connection with FIG. 1, it will be apparent that there are numerous embodiments contemplated for the presently disclosed system. Select embodiments will now be described, however it will be appreciated that these embodiments are not intended to be limiting in any way.

### Embodiment I

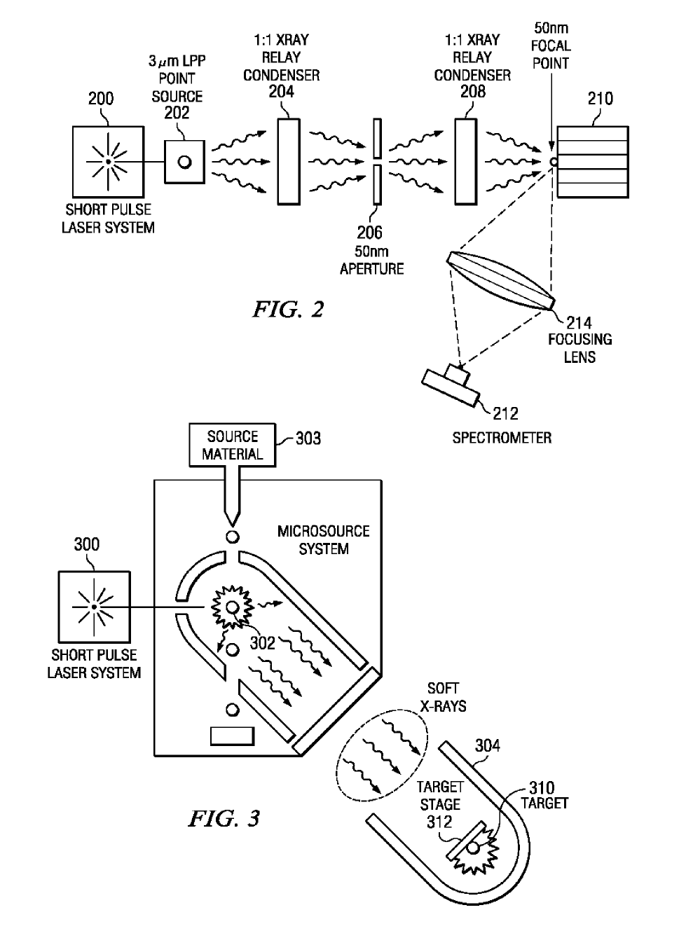

A first exemplary embodiment will now be discussed in connection with FIG. 2. The system shown in FIG. 2 is an example of a laser-produced plasma x-ray nanoplasma spectroscopy system (LPP-XNS). In this embodiment, the emissions source is embodied as a short-pulse laser system 200 and a target source 202. The target source 202 is preferably constructed of copper (Cu) and provided in the form of a tape or ribbon. Helium gas is circulated in the vicinity of the target source 202 for debris mitigation, thereby reducing contamination of system components. The laser source 200 preferably emits laser energy at 250 mJ/pulse having a pulse width of 800 ps at 300 Hz repetition. Other high-energy pulses are suitable, as long as they have sufficient energy to form a plasma at the target source 202. This laser energy is directed at the target source 202 to produce a plasma that serves as a 3 μm x-ray point source. An example of a suitable laser for the laser system 200 includes a diode-pumped Nd:YAG laser such as those discussed above. With this arrangement, a plasma can be produced on the target source 202 when irradiated by a laser pulse emitted by the laser system 200. The plasma thus produced emits x-ray radiation having a wavelength in the range of 0.5-8 nm, such as 3 nm.

The emissions optical system is embodied as a relay optical system that includes a first x-ray relay condenser 204, an aperture 206, and a second x-ray relay condenser 208. The aperture 206 can be a mask having an aperture diameter selected according to the x-ray wavelength and the desired size of the focal spot. In general, physics imposes a limit on the smallest size of the focal spot of about 1.22× the wavelength of the radiation. Thus, exemplary apertures can have a diameter of 30 nm, or, for example, any diameter less than 200 nm, or any diameter in a range of 20-200 nm or 30-100 nm, such as 50 nm. In a preferred embodiment, the first and second condensers 204 and 206 are 1:1 condenser elements such as a Fresnel zone plate. A Fresnel zone plate has alternating transparent and opaque zones in the form of concentric rings that result in a binary amplitude diffractive optic element that can be used as a lens. By blocking every other zone, planar light passing through the plate will constructively interfere at a focal point of the zone plate. The first and second condensers 204 and 206 can be, for example, zone plates where each zone plate has a zone plate transmission efficiency of 10%, an outermost delta r of 25 nm, 625 zones, a diameter of 62.5 μm, a focal length of 463.65 μm, an f-number of 7.42, and a spectral resolution (delta lambda/lambda) of 0.0016. Such zone plates have been fabricated by the Center for X-Ray Optics (CXRO) at the Lawrence Berkeley National Laboratory (LBNL) in Berkeley, Calif.

In the embodiment shown in FIG. 2, the target sample 210 is a nanomaterial with varied chemical composition on a nanometer scale, for example on a 50 nm length scale. Using the emissions system and emissions optics described above for the present embodiment, x-rays emitted from the target source 202 can be focused to achieve a focal spot having a diameter of 30 nm with a power density of 138 GW/cm² on the target sample 210. As a result, a nanoplasma can be formed having temperature is about 10⁵K. In the present embodiment, the spectrum (blackbody) of emissions from the plasma can be collected and evaluated using a conventional light gathering spectrometer 212. An f/3 collection optic 214 can be used to deliver approximately 10⁸ photons/second to the spectrometer. If, for example, the spectrometer 212 uses a 1024 linear array and is only 10% efficient, this would provide for collection of about 10⁴ photons/pixel/second, for a one second integration this would provide for a SNR of about 100 on each pixel. As an alternative, this embodiment can include a time of flight mass spectrometer to collect ions sputtered from the nanoplasma location and obtain additional information about the target sample 210. In some embodiments, the power density can be reduced such that a nanofluorescent spot is formed on the target sample 210 rather than a nanoplasma. The spectrometer is suitable for analyzing the nanofluorescent emissions as well.

### Embodiment II

A second exemplary embodiment will now be discussed in connection with FIG. 3. The system shown in FIG. 3 is another example of a laser-produced plasma x-ray nanoplasma spectroscopy system (LPP-XNS). In general, the system shown in FIG. 2 is best suited for shorter x-ray wavelengths, for example 2-nm. The present embodiment shown in FIG. 3 is better suited for longer x-ray wavelengths, for example >8 nm. In this embodiment, the emissions source is embodied as a short-pulse laser system 300 and a target source 302. The target source 302 preferably comprises xenon (Xe) and is provided in the form of a liquid jet; however, it will be appreciated that other target materials and/or forms of material can be used. The target source 302 is provided by a source material reservoir 303 and a jet apparatus. The laser source 300 preferably emits laser energy at 250 mJ/pulse having a pulse width of 800 ps at 300 Hz repetition. Other high-energy pulses are suitable, as long as they have sufficient energy to form a plasma at the target source 302. This laser energy is directed at the target source 302 to produce a plasma that serves as a 5 μm x-ray point source. An example of a suitable laser for the laser system 200 includes a diode-pumped Nd:YAG laser such as those discussed above. With this arrangement, a plasma can be produced on the target source 302 when irradiated by a laser pulse emitted by the laser system 300. The plasma thus produced emits x-ray radiation having a wavelength of >8 nm, such as 11 nm. Other examples of acceptable target delivery systems include the microtarget systems described in U.S. patent application Ser. No. 09/699,142 entitled “Radiation Generating System Using Microtargets and Method for Using Same,” which is hereby incorporated by reference into this specification.

The emissions optical system is embodied as a parabolic condenser 304. In a preferred embodiment, the parabolic condenser 304 is embodied as a parabolic multilayer mirror. The parabolic condenser 304 can be, for example, a parabolic Mo/Si multilayer reflector having an f-number below 1 and a diameter in a range of 0.5 to 10 inches. A suitable multilayer optic is commercially available from Osmic, Inc., of Auburn Hills, Mich.

In the embodiment shown in FIG. 3, a target sample 310 is supported by a 6-axis piezoelectric positioning stage having 10 nm resolution. Using the emissions system and emissions optics described above for the present embodiment, x-rays emitted from the target source 302 can be focused to achieve a focal spot having a diameter of 50 nm with an ablation power on the 50 nm spot of 0.2 W. For 1 ns pulse duration, ablation energy per pulse is 0.2 W×1 ns=0.2 nJ on the 50 nm spot. The laser system outputs 250 mJ/pulse at 300 Hz at the Xe target source 302 to produce soft x-rays having a wavelength of 111 nm and a conversion efficiency of ˜3% into 2πsr to yield soft x-ray (or EUV) power of 7.5 mJ. In this case, the x-ray energy into 0.1 msr=12 nJ and, for a mirror 304 having reflecting power R=0.6, the x-ray energy after reflection is 7.2 nJ, which is provided to the 50 nm spot on the target sample 310. This results in a nanoplasma ablation energy of 3×10¹¹ W/cm² or greater. At a lower repetition rate for the laser (˜10 Hz) the energy/pulse can be increased by another order of magnitude (>2 J/pulse) to yield 3×10¹² W/cm² or greater. Since the power density in this embodiment is similar to that of Embodiment 1, the photon budget to a spectrometer would be similar or the same.

### Embodiment III

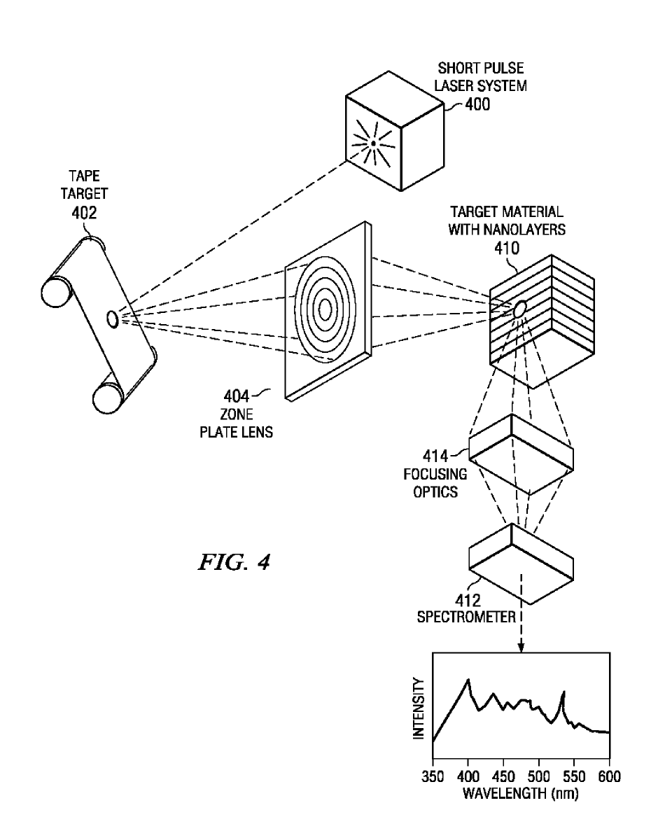

A third exemplary embodiment will now be discussed in connection with FIG. 4. The system shown in FIG. 4 is a further example of a laser-produced plasma x-ray nanoplasma spectroscopy system (LPP-XNS). In this embodiment, the emissions source is identical to that of Embodiment I discussed above, including a short-pulse laser system 400 and a copper target source 402 in the form of a tape or ribbon.

The emissions optical system is embodied as a relay optical system that includes a single x-ray relay condenser 404, which receives x-ray emissions from the target source 402 and refocuses the x-rays at a focal spot on a target sample 410. In a preferred embodiment, the condenser 404 is a Fresnel zone plate such as described above in connection with Embodiment I. Thus, the present embodiment differs from Embodiment I in that the aperture 206 and second condenser 208 are omitted in the present embodiment.

Further elements of the present embodiment can include a spectrometer 412 and collection optic 414 can be as discussed above in connection with Embodiment I.

### Embodiment IV

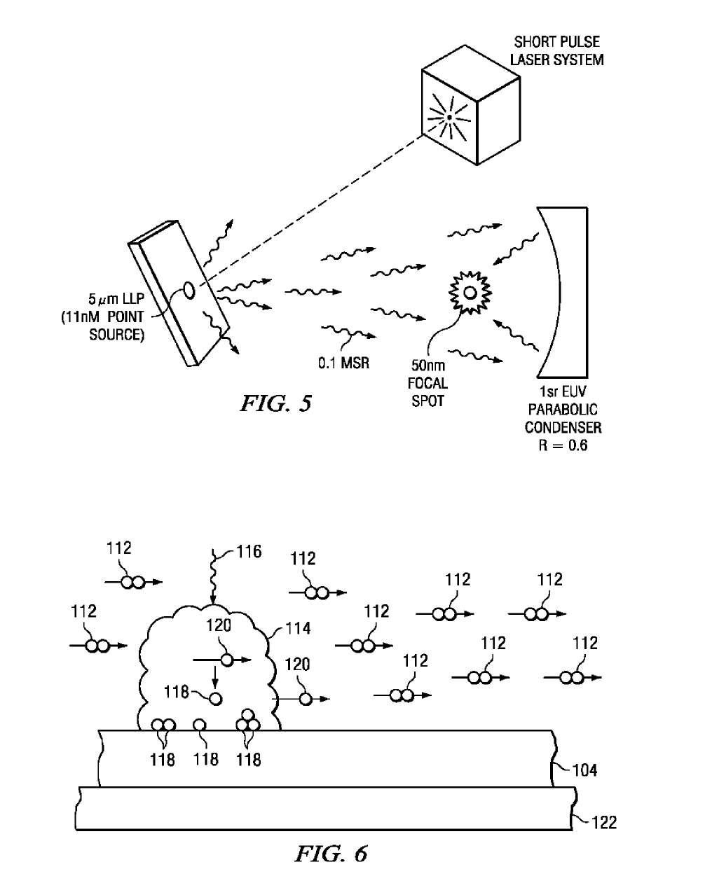

A fourth exemplary embodiment will now be discussed in connection with FIG. 5. The system shown in FIG. 5 is a further example of a laser-produced plasma x-ray nanoplasma spectroscopy system (LPP-XNS). In this embodiment, the emissions source is identical to that of Embodiment I discussed above, including a short-pulse laser system 500 and a target source 502.

The emissions optical system is embodied as a 1 sr EUV parabolic reflective condenser, which receives x-ray emissions from the target source 510 and reflects the x-rays onto a focal spot 504. Further elements of the present embodiment can include a spectrometer and collection optics as discussed above in connection with Embodiment 1.

### Further Embodiments

Still further embodiments incorporating systems and methods described above are contemplated. For example, it is contemplated that hybrid systems could be realized that incorporate several concepts discussed above. One such embodiment could be a system that is useful for a combination of one or more types of spectroscopy (e.g., light-gathering, time-of-flight, and/or electron spectroscopy) and/or one or more other applications including a nanomachining and/or a nano-deposition process. Such a system could be equipped with an emissions source that can be adjusted to control the power supplied to the target sample in accordance with the different requirements associated with different processes. For example, in a hybrid nanomachining/spectroscopy system the emissions system can be controlled (e.g., by adjustment of laser pulse energy or pulse frequency of the laser system 108 and/or changing the material used for the target material 110) such that the power can be increased to create a nanoplasma on the sample for a nanomachining process, then decreased to create a non-ablating nanofluorescent spot for a chemical analysis process.

Other possible applications of this invention include an x-ray transmission microscope and a photoelectron analyzer. According to these embodiments, a short pulse laser system with a less powerful amplifier is preferred. In addition, other radiation sources can be used for generating x-rays or soft x-rays of the desired wavelength. For the x-ray transmission microscope embodiment, the target would comprise a micro-size or nano-size sample to be imaged. The x-rays transmitted through or reflected by the sample could be collected by a CCD array to generate an image of the sample, or an image of a desired polymer structure. This device would have the advantage of a resolution in the range of 20 nm-200 nm. For the photoelectron analyzer, a nanoplasma or nanofluorescent spot could be formed on the target material with sufficient energy to eject electrons from the target. Materials analysis could be conducted by analyzing the energy of the ejected electrons.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims.

Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A nanoplasma-generating device, comprising:
an emissions source that includes a short-pulse laser system and a radiation source, the laser system operable to generate a laser pulse having an energy density sufficient to form a point plasma at the radiation source that emits short-wavelength radiation; and
a focusing optic for receiving the short-wavelength radiation from the radiation source and focusing the radiation onto a target to form a nanoplasma.

2. A device according to claim 1, wherein said short-wavelength radiation has a wavelength in a range of 0.5 nm to 15 nm.

3. A device according to claim 1, wherein said focusing optic includes at least one Bragg multilayer coating.

4. A device according to claim 1, wherein said focusing optic includes at least one of a grazing incidence optical element and a diffractive optical element.

5. A device according to claim 1, wherein said focusing optic is for focusing the radiation onto the target such that the nanoplasma has a diameter of less than 200 nm.

6. A device according to claim 1, further comprising a positioning stage for positioning the target.

7. A device according to claim 1, wherein the laser pulse generated by the short-pulse laser system has a pulse width of less than one nanosecond and an energy of at least 200 mJ.

8. A device according to claim 7, wherein the radiation source comprises a metallic tape.

9. A device according to claim 8, wherein the focusing optic comprises a first relay condenser, an intermediate aperture, and a second relay condenser, wherein the first relay condenser is operable to receive the short-wavelength radiation from the radiation source and focus the radiation onto the intermediate aperture, and wherein the intermediate aperture permits the passage of the short-wavelength radiation to the second relay condenser, and wherein the second relay condenser is operable to receive the short-wavelength radiation from the intermediate aperture and focus the radiation onto the target.

10. A device according to claim 1, further comprising an analyzing assembly for performing a spectroscopic analysis of the target based on radiation emitted from the nanoplasma.

11. A device according to claim 1, wherein the nanoplasma causes ablation of material of the target.

12. A device according to claim 1, wherein a reactive gas is provided in the vicinity of the target, wherein the nanoplasma causes reaction of the reactive gas so that a resultant is produced and deposited on the target.

13. A method for generating a nanoplasma comprising:
providing a laser pulse having an energy density sufficient to form a point plasma at a radiation source so as to generate short-wavelength radiation;
generating a nanoplasma by focusing the short-wavelength radiation onto a spot on a target.

14. A method according to claim 13, wherein said short-wavelength radiation has a wavelength in a range of 0.5 nm to 15 nm.

15. A method according to claim 13, wherein step of focusing is performed at least in part by an optical element having a Bragg multilayer coating.

16. A method according to claim 13, wherein said step of focusing is performed at least in part by at least one of a grazing incidence optical element and a diffractive optical element.

17. A method according to claim 13, wherein the nanoplasma has a diameter of less than 200 nm.

18. A method according to claim 13, further comprising a step of controlling a positioning stage in order to position the target.

19. A method according to claim 13, wherein the laser pulse has a pulse width of less than one nanosecond and an energy of at least 200 mJ.

20. A method according to claim 19, wherein the radiation source comprises a metallic tape.

21. A method according to claim 20, wherein the focusing of the short-wavelength radiation comprises:
receiving short-wavelength radiation from the radiation source at a relay condenser and focusing the radiation onto an intermediate aperture;
permitting the passage of the short-wavelength radiation through the intermediate aperture to a second relay condenser; and
receiving the short-wavelength radiation at the second relay condenser and focusing the radiation onto the spot on the target.

22. A method according to claim 13, further comprising performing a spectroscopic analysis of the target based on radiation emitted from the nanoplasma.

23. A method according to claim 13, wherein the generating of the nanoplasma includes ablating an amount of material from the target.

24. A method according to claim 13, further comprising providing a reactive gas in the vicinity of the target, wherein the generating of the nanoplasma includes causing reaction of the reactive gas so that a resultant is produced and deposited on the target.

25. A nanofluorescence-generating device, comprising:
a short-pulse laser system operable to generate a laser pulse having an energy density sufficient to form a point plasma at a radiation source that emits short-wavelength radiation; and
a focusing optic operable to receive the short-wavelength radiation from the radiation source and focus the radiation onto a target so that a nanofluorescent spot is formed.

26. A device according to claim 25, wherein the laser pulse has a pulse width of less than one nanosecond and an energy of at least 200 mJ.

27. A device according to claim 26, wherein the radiation source comprises a metallic microtarget.

28. A device according to claim 27, wherein the focusing optic comprises:
a first parabolic reflector having a focal point substantially aligned with the radiation source, the first parabolic reflector comprising multilayer interference films operable to reflect and substantially collimate short-wavelength radiation emitted by the radiation source; and
a second parabolic reflector having a focal point substantially aligned with the target, the parabolic reflector comprising multilayer interference films operable to reflect and focus short-wavelength radiation onto a spot on the target having a diameter less than 200 nm so as to generate a nanofluorescent spot.

29. A device according to claim 25, further comprising an analyzing assembly for performing a spectroscopic analysis of the target based on radiation from the nanofluorescent spot.

30. A device according to claim 25, wherein the nanofluorescent spot has a diameter of less than 200 nm.

31. A method for generating a nanofluorescent spot comprising:
providing a laser pulse having an energy density sufficient to form a point plasma at a radiation source that emits short-wavelength radiation; and
generating a nanofluorescent spot by focusing the short-wavelength radiation onto a spot on a target.

32. A method according to claim 31, wherein the laser pulse has a pulse width of less than one nanosecond and an energy of at least 200 mJ.

33. A method according to claim 32, wherein the generating of the short-wavelength radiation source comprises a metallic microtarget.

34. A method according to claim 33, wherein the focusing of the radiation comprises:
reflecting and collimating the short-wavelength radiation emitted by the radiation source with a first parabolic reflector having a focal point substantially aligned with the radiation source, the first parabolic reflector comprising multilayer interference films; and
reflecting and focusing the short-wavelength radiation onto the spot on the target with a second parabolic reflector having a focal point substantially aligned with the target, the second parabolic reflector comprising multilayer interference films.

35. A method according to claim 31, further comprising performing a spectroscopic analysis of the target based on radiation from the nanofluorescent spot.

36. A method according to claim 31, wherein the nanofluorescent spot has a diameter of less than 200 nm.
